(19) United States
(12) Patent Application Publication
(10) Pub. No.: US 2017/0030155 A1
(43) Pub. Date: Feb. 2, 2017

(54) Shaker Screen System

(71) Applicant: Gary W. Crook, Midland, TX (US)

(72) Inventor: Gary W. Crook, Midland, TX (US)

(21) Appl. No.: 14/816,019

(22) Filed: Aug. 2, 2015

(51) Int. Cl. E21B 21/06; G07C 3/02; B07B 1/28

(52) U.S. Cl. CPC E21B 21/066; B07B 1/28; G07C 3/02

(57) ABSTRACT

A shaker screen system for use during a well-drilling operation at an oilfield involves the use of a shale shaker and a main container that stores an assortment of replacement screens for the shaker. Each screen has an affixed ID marker (e.g., an RFID tag). An ID reader monitors the inventory of screens in the main container. As screens are removed from the main container and installed in the shaker, the ID reader collects and records data pertaining to the event along with other related events such which screen was removed, who removed it, when was it removed, etc. The data provides a recorded history of events that are wirelessly transmitted to a remote offsite location. In some examples, the shale shaker destroys the ID marker to ensure the used screen is not later mistaken for a new one.

### CROSS REFERENCE TO RELATED APPLICATIONS

This application claims the benefit of provisional patent application Ser. No. 61/171,223 (herein incorporated by reference) filed on Jun. 4, 2015 by the present inventor.

### FIELD OF THE DISCLOSURE

This patent application generally pertains to the use of shaker screens in oilfields and more specifically to a system and method for managing the screens.

### BACKGROUND

Shale shakers with various size screens are used for screening rocks, particles and other solid materials associated with the process of drilling a wellbore at an oilfield. The particles are removed from a liquid slurry known as drilling fluid or mud. The particles are sometimes referred to as “cuttings.” The drilling fluid provides cooling, lubrication and helps remove the cuttings out from within the well bore.

### BRIEF DESCRIPTION OF THE DRAWINGS

FIG. 1 is a schematic diagram showing an example shaker screen system configured in accordance with the teachings disclosed herein.

FIG. 2 is another schematic diagram of the system shown in FIG. 1.

FIG. 3 is another schematic diagram of the system shown in FIGS. 1 and 2.

FIG. 4 is a block diagram illustrating an example shaker screen method involving the use of the shaker screen system shown in FIGS. 1-3.

### DETAILED DESCRIPTION

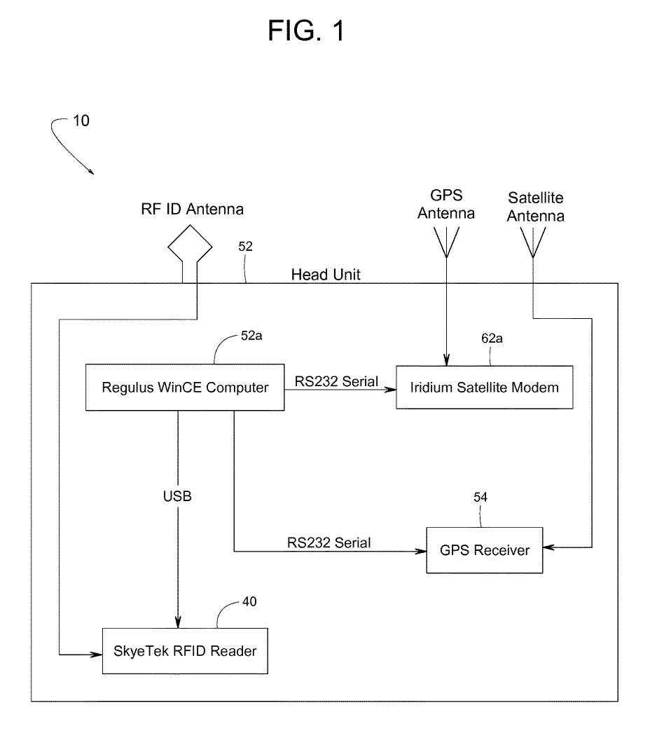

FIGS. 1-4 illustrate an example shaker screen system 10 and shaker screen method 12 for tracking the use of shaker screens 30 at an oilfield 14. A slurry is produced and used in the process of drilling a wellbore 16 at oilfield 14. Screens 30 help in creating a finer slurry 18b by separating particles 46 from a course slurry 18a extracted from wellbore 16 during the drilling process.

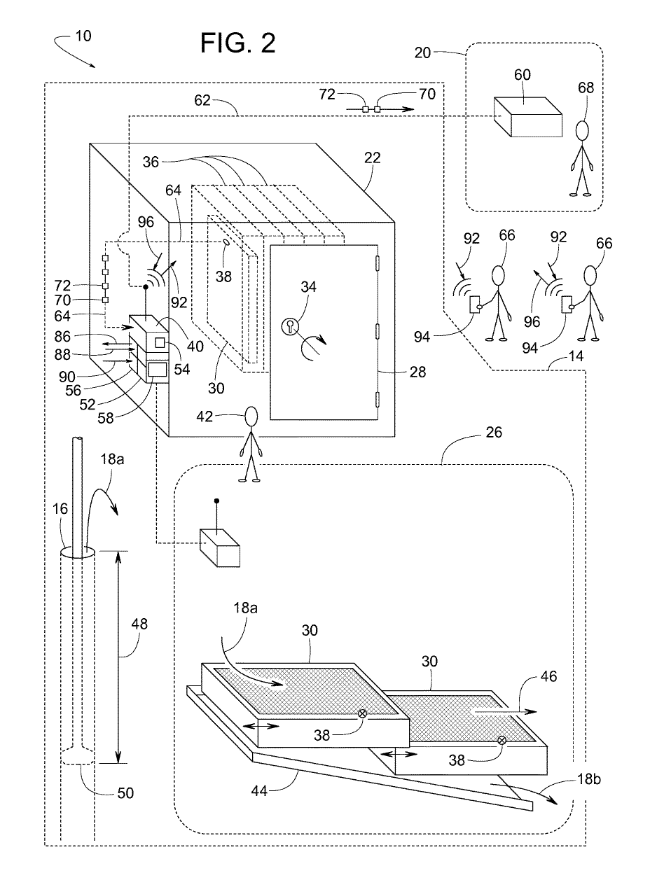

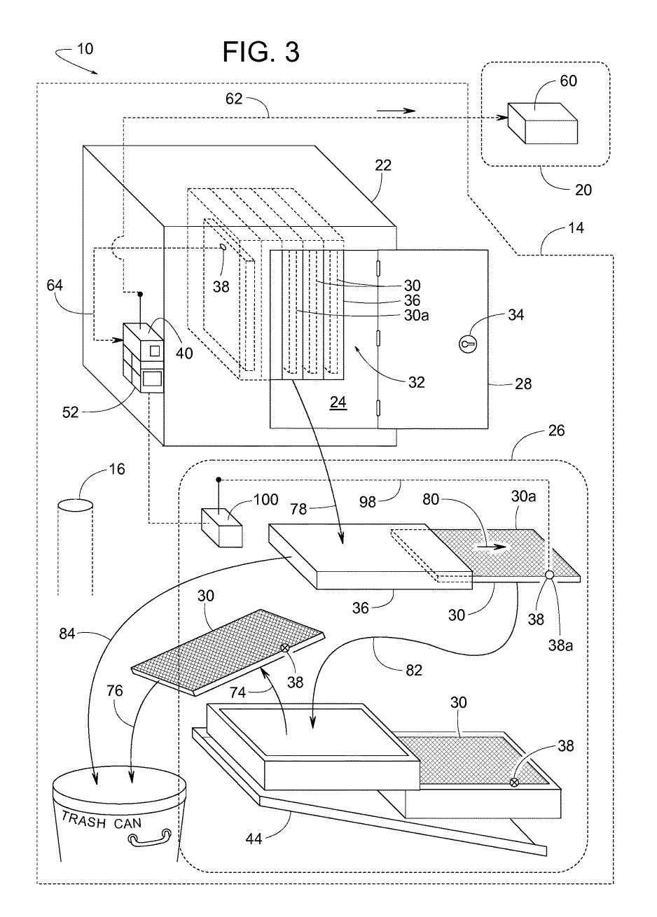

One example of a shaker screen system 10, for use at oilfield 14 and with further extended use at a remote area 20 beyond oilfield 14, comprises a main container 22 at oilfield 14, wherein main container 22 defines an interior space 24 and a predetermined exterior area 26 beyond interior space 24. For security and/or for protecting the main container's contents, some examples of main container 22 include a door 28 having an open position (FIG. 3) and a closed position (FIG. 2). Door 28 in the closed position blocks a passageway 32 between interior space 24 and the predetermined exterior area 26. Door 28 in the open position unblocks passageway 32 to provide access to interior space 24. In some examples, door 28 has a lock 34 that is configurable selectively to a locked state (FIG. 2) and an unlocked state (FIG. 3).

In the illustrated example, shaker system 10 also comprises a plurality of subcontainers 36 (e.g., cardboard boxes) with at least some of them being inside main container 22. The plurality of subcontainers 36 contain a corresponding plurality of screens 30 with a corresponding plurality of ID markers 38 on screens 30. Shaker system 10 further comprises an ID reader 40 having a limited range of communication distance; however, the limited range is sufficient for detecting (communicating with) ID markers 38 when markers 38 are somewhere within interior space 24 of main container 22. An ID marker 38 is beyond the range of communication with ID reader 40 when that marker is within predetermined exterior area 26 or otherwise beyond the ID reader's range of marker detection.

The term, “ID marker” refers to any feature, item or apparatus that can communicate information wirelessly through air to a suitable reader. ID marker 38 is schematically illustrated to represent any type of ID marker. The term, “ID reader” refers to any known apparatus capable of receiving information wirelessly through air from a compatible ID marker. Examples of ID marker 38 include, but are not limited to, an RFID tag (radio frequency identification), barcode (optical machine-readable series of lines of various widths and various spacing), QR code (Quick Response Code and registered trademark of Denso Wave Inc. of Japan), RUBEE (registered trademark of Visible Assests, Inc. of Ontario, Canada), Memory Spot chip (provided by Hewlett-Packard of Palo Alto, Calif.), and 3-D printed features (e.g., InfraStructs as developed by Microsoft of Redmond, Wash.). In some examples, ID marker 38 is an RFID tag, and ID reader 40 is a SkyeTek RFID reader provided by SkyeTek of Denver, Colo.

In operation, some examples of shaker screen system 10 and shaker screen method 12 can be carried out as follows. A worker 42 (e.g., field hand, screen delivery person, etc.) delivers a supply of screens 30 to oilfield 14, unlocks lock 34 on door 28, opens door 28 from its closed position (FIG. 2) to its open position (FIG. 3), carries screens 30 through passageway 32 (doorway), places screens 30 inside main container 22, and then shuts and locks door 28. Screens 30 are stored in main container 22 as onsite inventory for later use as needed. In some examples, screens 30 are in an assortment of sizes and/or specifications (e.g., mesh size, wire size, hole size, API number, screen manufacturer, overall width, length, thickness, etc.) to meet the needs of the oil drilling and slurry screening process. A “5 FS API 140 Mesh” is one example of a screen size.

In the screening process, a screen shaker 44 (also known as a shale shaker) shakes one or more chosen screens 30a to promote the removal of particles 46 that exceed a certain size. The chosen particle size, and thus chosen screen 30a, may vary depending on the drill depth 48 of the well drilling process (see drill bit 50). As drill depth 48 reaches a certain depth and/or as screens 30 wear out during the screening process, used screens are discarded and replaced. Sometimes a discarded screen 30 is replaced by a new one of equivalent size, and other times screen 30 is replaced by one of a different size.

In some examples, shaker screen system 10 includes a local computer system 52 (head unit) including, or being at least associated with, a GPS receiver 54, ID reader 40, an input device 56 (e.g., keypad, touch-screen, card reader, etc.), and a display 58. In this example, shaker screen system 10 also includes a distant computer system 60 (e.g., a web server, network of remote servers hosted on the Internet, home base computer, one or more computers, etc.) at location 20 that is remote relative to main container 22, a long distance communication link 62 (e.g., cell tower communication, satellite communication, Iridium Satellite modem 62a, Wi-Fi transceiver, Ethernet cable, Cell CDMA/GSM, radio waves, various combinations thereof, etc.) connecting local computer system 52 in wireless communication with distant computer system 60, a first local communication link 64 (radio waves/field, magnetic waves/field, etc.) connecting ID reader 40 in wireless communication with ID markers 38, and means for local computer system 52 of detecting the actuation of lock 34.

Together, shaker screen system 10 collects and transfers data pertaining to screen inventory, screen usage and/or various events at oilfield 14. In addition or alternatively, system 10 provides various prompts (requests for input), notifications and other communications to various individuals such as one or more workers 42, one or more advisors 66 (e.g., engineers, supervisors, consultants, etc.), and one or more customers 68 (e.g., well owner, project coordinator, drill service company representative, etc.).

In one example scenario, worker 42 delivers an assortment of screens 30 from a screen supplier to oilfield 14. Worker 42 enters a worker identification number into input device 56 of local computer system 52, and worker 42 unlocks and opens door 28. Worker 42 leaves the ordered assortment of screens 30 inside main container 22 and then closes and locks door 28.

With the ID markers 38 of screens 30 inside main container 22 and being within the ID reader's range of communication, ID reader 40 detects ID markers 38 via first local communication link 64 conveying data from ID marker 38 to local computer system 52, whereby local computer system 52 collects data such as an inventory list of screens 30 in main container 22. The collected data from ID markers 38 contains various information, examples of which include, but are not limited to, the total number of screens 30 in main container 22, screen manufacturer identifiers 70 (e.g., manufacturer's name), and screen sizes 72 (e.g., mesh size, wire size, hole size, screen width, screen length, screen thickness, etc.).

Local computer system 52 also records other data such as the worker's identification number, a timestamp indicating the time of day that worker 42 entered input into local computer system 52, a date stamp indicating the date that worker 42 entered input into local computer system 52, a timestamp indicating the time of day that lock 34 was unlocked, a date stamp indicating the date that lock 34 was unlocked, an API number associated with wellbore 16, and/or the main container's GPS coordinates as provided by GPS receiver 54. Long distance communication link 62 conveys at least some or all of this data from local computer system 52 to distant computer system 60. Distant computer system 60 processes or records the information and/or makes the information available to customer 68 and other authorized individuals via a website with a login screen.

At some point during this example scenario of operation, worker 42 replaces one of the screens 30 being used in screen shaker 44. Arrow 74 of FIG. 3 represents worker 42 removing the used screen 30, and arrow 76 represents discarding that screen. To replace the used screen, worker 42 enters a worker identification number into local computer system 52 and/or unlocks and opens door 28. Worker 42 then selects a chosen screen 30a as a replacement. Arrow 78 represents worker 42 removing chosen screen 30a out from within main container 22. Worker 42 then closes and locks door 28. Arrow 80 represents worker 42 removing chosen screen 30a out from within subcontainer 36, and arrow 84 represents discarding subcontainer 36. Chosen screen 30a has a chosen ID marker 38a that stays with screen 30a even after discarding subcontainer 36. Arrow 82 represents worker 42 installing chosen screen 30a in screen shaker 44 to replace the previously used and currently discarded screen 30.

During the process of replacing a used screen 30 with a new chosen screen 30a, local computer system 52 collects additional or updated data with example information including, but not limited to, an updated total number of screens 30 remaining after the chosen screen 30a was removed from main container 22, screen manufacturer identifier 70 of chosen screen 30a, and the chosen screen's size (e.g., mesh size, wire size, hole size, screen width, screen length, screen thickness, etc.). The updated data may include additional information, examples of which include, but are not limited to, the identification number of the worker that removed chosen screen 30a, a timestamp indicating the time of day when worker 42 entered input into local computer system 52 around the time that worker 42 removed chosen screen 30a, a date stamp indicating the date that worker 42 entered input into local computer system 52 around the time that worker 42 removed chosen screen 30a, a timestamp indicating the time of day that lock 34 was unlocked to remove chosen screen 30a, and/or a date stamp indicating the date that lock 34 was unlocked to remove chosen screen 30a. Long distance communication link 62 conveys at least some or all of this updated data from local computer system 52 to distant computer system 60. Distant computer system 60 processes or records the information and/or makes the information available to customer 68 and other authorized individuals.

Such collected data and information offers many benefits. Shaker screen system 10, for instance, can determine which screens 30 are actually used, so customer 68 can be charged accordingly. In some examples, computer systems 52 and/or 60 provides an excess usage notification 86 (e.g., message or alarm) if the rate of screen usage (variable value) equals or exceeds a predetermined limit. In other words, computer system 52 and/or 60 computes a differential value by comparing (e.g., subtracting) the variable value to the predetermined limit and provides the excess usage notification 86 based on the computed differential value. The collected data also provides others remote access to inventory figures so that screen suppliers can replenish the stock without having to first visit the site to check inventory levels. In addition, the collected data can be saved to establish a documented history of various events that occurred at oilfield 14.

After the installation of the newly added chosen screen 30a, screen shaker 44 continues its shaking and screening operation. In some examples, ID marker 38 has a structure, mounting location and/or other characteristic such that the screening operation naturally destroys, leads to its destruction, or renders the ID marker 38 inoperative and thus unable to communicate with ID reader 40, regardless of the reader and marker's relative proximity. In other words, ID marker 38 is configurable from a functional state prior to use to a damaged state as a result of use. The damage can be caused by abrasion, water damage and/or severe vibration. This change in state is schematically illustrated in FIG. 3, wherein a circle without an “X” represents ID marker 38 in the functional state, and a circle with an “X” represents ID marker 38 in the damaged state. Changing ID marker 38 from a functional state to a damaged state helps ensure that ID reader 40 never mistakenly detects an ID marker of a used screen 30 and misinterprets that screen as being a new one.

In some examples, shaker screen system 10 monitors the drilling process and enlists the help of one or more advisors 66 in determining the next replacement screen 30 for screen shaker 44. For instance, in some examples, in response to local computer system 52 detecting that a chosen screen 30a is being removed from main container 22 and/or in response to local computer system 52 detecting that door 28 has been unlocked, local computer system 52 emits a drill depth prompt 88 (e.g., an audible or visual signal). In some examples, drill depth prompt 88 indicates that local computer system 52 is prepared and waiting for worker 42 to enter an input 90 that indicates the current drill depth 48 of oil well 16, which is in the process of being drilled. The current drill depth 48 indicates the progress of the drilling, rather than the anticipated final drill depth at completion. In some examples, local computer system 52 continues to emit drill depth prompt 88 until worker 42 enters the current drill depth 48.

In response to worker 42 entering current drill depth 48, local computer system 52 and/or distant computer system 60 specifies which screen 30 should be chosen as the next replacement screen for shaker 44. In addition or alternatively, some examples of shaker screen system 10 sends an outgoing text message 92 (e.g., via Android application, iOS application, Windows Phone application, etc.) to one or more portable digital devices 94 (e.g., cellphone, personal computer, etc.) of one or more advisors 66 (remote supervisor, engineer, consultant, etc.). Outgoing message 92 can provide various information such as chosen screen 30a has been removed from main container 22, a request for advice regarding which screen 30 should be chosen as the next replacement screen, door 28 has been unlocked, and/or current drill depth 48 has been entered. In response to receiving outgoing message 92, advisor 66 sends a response message 96 from portable digital device 94 to local computer system 52. Examples of response message 96 include, but are not limited to, a recommended screen size, an acknowledgment of having received outgoing message 92, an approval of the worker's chosen screen 30a, or a disapproval of the worker's chosen screen 30a.

Some examples of shaker screen system 10 include a second local communication link 98 that connects a second ID reader 100 of local computer system 52 in wireless communication with chosen ID marker 38a of chosen screen 30a when chosen screen 30a is in the predetermined area 26 beyond interior space 24 and beyond the range of the first ID reader 40. This enables local computer system 52 to collect data indicating that chosen screen 30a was actually installed in shaker 44 or at least in the vicinity of shaker 44, rather than just removed from main container 22. Some examples of ID marker 38 are sufficiently durable to survive the rough treatment in shaker 44. In such examples, ID reader 100 can detect not only when chosen screen 30a is installed in shaker 44, but ID reader 100 can also determine when chosen screen 30a is later removed from shaker 44.

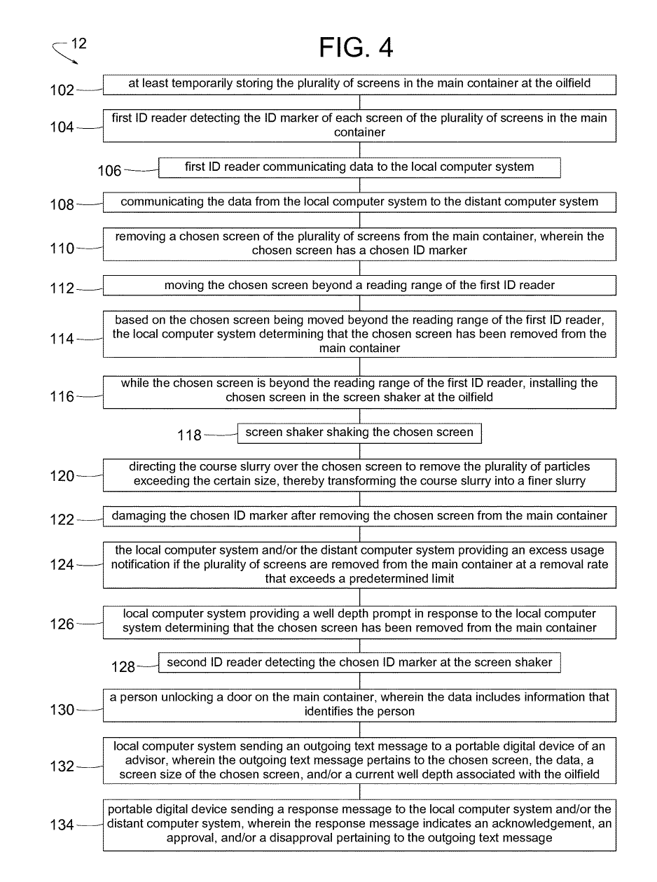

FIG. 4 illustrates one example of shaker screen method 12, wherein block 102 represents at least temporarily storing screens 30 in main container 22 at oilfield 14. Block 104 represents first ID reader 40 detecting ID marker 38 of each screen 30 in main container 22. Block 106 represents first ID reader 40 communicating data to local computer system 52, wherein the data pertains to an inventory of screens 30 in main container 22. Block 108 represents communicating the data from local computer system 52 to distant computer system 60. Block 110 represents removing chosen screen 30 from main container 22, wherein chosen screen 30 has chosen ID marker 38. Block 112 represents moving chosen screen 30 beyond a reading range of first ID reader 40. Block 114 represents based on chosen screen 30a being moved beyond the reading range of first ID reader 40, local computer system 52 determining that chosen screen 30a has been removed from main container 22. Block 116 represents while chosen screen 30a is beyond the reading range of first ID reader 40, installing chosen screen 30a in screen shaker 44 at oilfield 14. Block 118 represents screen shaker 44 shaking chosen screen 30a. Block 120 represents directing course slurry 18a over chosen screen 30a to remove the plurality of particles 46 exceeding a certain size, thereby transforming course slurry 18a into finer slurry 18b. Block 122 represents damaging chosen ID marker 38a after removing chosen screen 30a from main container 22. Block 124 represents at least one of local computer system 52 and distant computer system 60 providing excess usage notification 86 if screens 30 are removed from main container 22 at a removal rate that exceeds a predetermined limit. Block 126 represents local computer system 52 providing drill depth prompt 88 in response to local computer system 52 determining that chosen screen 30a has been removed from main container 22. Block 128 represents second ID reader 100 detecting chosen ID marker 38a at screen shaker 44. Block 130 represents a person (e.g., worker 42) unlocking door 28 on main container 22, wherein the data includes information that identifies the person. Block 132 represents local computer system 52 sending outgoing text message 92 to portable digital device 94 of advisor 66, wherein outgoing text message 92 pertains to at least one of chosen screen 30a, the data, a screen size of chosen screen 30a, and the current drill depth 48 associated with oilfield 14. Block 134 represents portable digital device 94 sending response message 96 to local computer system 52 and/or distant computer system 60, wherein response message 96 indicates an acknowledgement, an approval, and/or a disapproval pertaining to outgoing text message 92.

Here are some additional points worth mentioning. The term, “worker” refers to one or more individuals at oilfield 14. In some examples, predetermined exterior area 26 encompasses the area in which shaker 44 is operating. The term, “remote” refers to a distance of at least one mile, and the term, “local” refers to a distance of less than a mile. Examples of local computer system 52 and associated components include, but are not limited to, a Regulus WinCE computer 52a, Windows CE embedded computer, Windows Mini PC, Windows Tablet, Windows handheld. In some examples, the purpose of subcontainer 36 is to help shelter not only screen 30 but to also shelter ID marker 38 prior to installing screen 30 in shaker 44. So when screen 30 and its attached ID marker 38 are removed from within subcontainer 36, ID marker 38 becomes unsheltered and thus more exposed and vulnerable to damage. Thus, it becomes easier to damage ID marker 38 while screen 4 is in use in screen shaker 44, which is beneficial in examples where the intention is to change ID marker 38 from its functional state to its damaged state as a result of using screen 30.

Although certain example methods, apparatus and articles of manufacture have been described herein, the scope of the coverage of this patent is not limited thereto. On the contrary, this patent covers all methods, apparatus and articles of manufacture fairly falling within the scope of the appended claims either literally or under the doctrine of equivalents.

1. A shaker screen system for use at an oilfield and beyond the oilfield, the shaker screen system being at least sometimes usable by at least one of a customer, a worker at the oilfield, and an advisor with a portable digital device; the shaker screen system comprising:
a main container at the oilfield, the main container defining an interior space and a predetermined exterior area located beyond the interior space, the main container including a door having an open position and a closed position, the door in the closed position blocking a passageway between the interior space and the predetermined exterior area, the door in the open position unblocking the passageway between the interior space and the predetermined exterior area;
a plurality of subcontainers, at least some of the plurality of subcontainers being in the main container, the plurality of subcontainers containing a plurality of screens;
a plurality of RFID tags on the plurality of screens;
an RFID reader being within communication with the plurality of RFID tags when the plurality of subcontainers are in the main container with the plurality of screens in the plurality of subcontainers, the RFID reader being beyond communication with a chosen RFID tag when a chosen screen of the plurality of screens is moved from within the interior space of the main container to the predetermined exterior area; and
a distant computer system at a location that is remote relative to the main container, the remote computer system being in wireless communication with the RFID reader, the remote computer system collecting data from the RFID reader regarding which of the plurality of screens are in the interior space of the main container.

2. The shaker screen system of claim 1, further comprising a screen shaker for holding and shaking the chosen screen, the chosen RFID tag being configurable selectively from a functional state to a damaged state, the RFID tag in the functional state being capable of communicating with the RFID reader when the RFID tag is proximate the RFID reader, the RFID tag in the damaged state being unable to communicate with the RFID reader when the RFID tag is proximate the RFID reader, the RFID tag changing from the functional state to the damaged state as a consequence of the chosen screen being used on the screen shaker.

3. A shaker screen system for use at an oilfield and beyond the oilfield, the shaker screen system being at least sometimes usable by at least one of a customer, a worker at the oilfield, and an advisor with a portable digital device; the shaker screen system comprising:
a main container at the oilfield, the main container defining an interior space and a predetermined exterior area located beyond the interior space;
a plurality of subcontainers, at least some of the plurality of subcontainers being in the main container, the plurality of subcontainers containing a plurality of screens;
a plurality of ID markers on the plurality of screens;
a local computer system at the oilfield, the local computer system including a first ID reader;
a first local communication link connecting the first ID reader in communication with the plurality of ID markers when the plurality of subcontainers are in the main container with the plurality of screens in the plurality of subcontainers, the first local communication link communicating data from the plurality of ID markers to the first ID reader, the first ID reader being beyond communication with a chosen ID marker on a chosen screen of the plurality of screens when the chosen screen is moved from within the interior space of the main container to the predetermined exterior area, the local computer system collecting the data from the first ID reader, wherein the data indicates which of the plurality of screens are in the interior space of the main container;
a distant computer system at a location that is remote relative to the main container; and
a long distance communication link connecting the local computer system in wireless communication with the distant computer system, the long distance communication link communicating the data from the local computer system to the distant computer system.

4. The shaker screen system of claim 3, wherein the data includes a screen manufacturer identifier pertaining to at least one screen of the plurality of screens.

5. The shaker screen system of claim 3, wherein the data includes a screen size pertaining to at least one screen of the plurality of screens.

6. The shaker screen system of claim 3, wherein the data includes a time-of-day stamp.

7. The shaker screen system of claim 3, wherein the data includes a date stamp.

8. The shaker screen system of claim 3, further comprising a GPS receiver associated with the local computer system, and the data includes a GPS coordinate value provided by the GPS receiver.

9. The shaker screen system of claim 3, further comprising:
a variable value indicating a quantity of how many of the plurality of screens are removed from the main container as determined by the ID reader;
a predetermined limit stored on at least one of the local computer system and the distant computer system;
a differential value computed by at least one of the local computer system and the distant computer system, the differential value being based on a comparison of the variable value to the predetermined limit; and
an excess usage notification provided by at least one of the local computer system and the distant computer system, the excess usage notification being provided in response to the differential value.

10. The shaker screen system of claim 3, further comprising a drill depth prompt provided by the local computer system in response to the local computer system determining that the chosen screen had been removed from the main container, the drill depth prompt indicating that the local computer system is prepared to receive an input indicating a current drill depth associated with the oilfield.

11. The shaker screen system of claim 3, further comprising a screen shaker for holding and shaking the chosen screen beyond the interior space, the chosen ID marker being configurable selectively from a functional state to a damaged state, the chosen ID marker in the functional state being capable of communicating with the first ID reader when the chosen ID marker is proximate the first ID reader, the chosen ID marker in the damaged state being unable to communicate with the first ID reader when the chosen ID marker is proximate the first ID reader, the chosen ID marker changing from the functional state to the damaged state as a consequence of the chosen screen being used on the screen shaker.

12. The shaker screen system of claim 3, further comprising a screen shaker for holding and shaking the chosen screen beyond the interior space.

13. The shaker screen system of claim 12, wherein the local computer system includes a second ID reader, and the shaker screen system further comprises a second local communication link connecting the second ID reader in communication with the chosen ID marker when the chosen screen is in the predetermined exterior area.

14. The shaker screen system of claim 13, wherein the data indicates whether the chosen screen was installed in the screen shaker.

15. The shaker screen system of claim 13, wherein the data indicates whether the chosen screen was removed from the screen shaker.

16. The shaker screen system of claim 3, further comprising:
a door on the main container, the door having an open position and a closed position, the door in the closed position blocking a passageway between the interior space and the predetermined exterior area, the door in the open position unblocking the passageway between the interior space and the predetermined exterior area; and
a lock on the door, the lock being selectively configurable to a locked state and an unlocked state, the lock changing from the locked state to the unlocked state in response to a predetermined action of the worker at the oilfield, the data further including information pertaining to an identity of the worker and information pertaining to the lock changing from the locked state to the unlocked state.

17. The shaker screen system of claim 3, further comprising an outgoing text message communicated from the local computer system to a plurality of portable digital devices of a plurality of advisors, wherein the outgoing text message pertains to at least one of the chosen screen, the data, a screen size of the chosen screen, and a current drill depth associated with the oilfield.

18. The shaker screen system of claim 3, further comprising an outgoing text message communicated from the local computer system to the portable digital device of the advisor, wherein the outgoing text message pertains to at least one of the chosen screen, the data, a screen size of the chosen screen, and a current drill depth associated with the oilfield.

19. The shaker screen system of claim 18, further comprising a response message communicated from the portable digital device of the advisor to at least one of the local computer system and the distant computer system, wherein the response message indicates at least one of an acknowledgement, an approval, and a disapproval pertaining to the outgoing text message.

20. The shaker screen system of claim 3, further comprising a website provided by the distant computer system, the website displaying a login screen that provides the customer with access to view the data.

21. A shaker screen method for screening a course slurry at an oilfield, wherein the course slurry includes a plurality of particles exceeding a certain size, the shaker screen method involving the use of at least one of a local computer system associated with a first ID reader, a second ID reader associated with the local computer system, a distant computer system, a main container, a screen shaker spaced apart from the main container, and a plurality of screens each of which has an ID marker; the shaker screen method comprising:
at least temporarily storing the plurality of screens in the main container at the oilfield;
the first ID reader detecting the ID marker of each screen of the plurality of screens in the main container;
the first ID reader communicating data to the local computer system, wherein the data pertains to an inventory of the plurality of screens in the main container;
communicating the data from the local computer system to the distant computer system;
removing a chosen screen of the plurality of screens from the main container, wherein the chosen screen has a chosen ID marker;
moving the chosen screen beyond a reading range of the first ID reader;
based on the chosen screen being moved beyond the reading range of the first ID reader, the local computer system determining that the chosen screen has been removed from the main container;
while the chosen screen is beyond the reading range of the first ID reader, installing the chosen screen in the screen shaker at the oilfield;
the screen shaker shaking the chosen screen; and
directing the course slurry over the chosen screen to remove the plurality of particles exceeding the certain size, thereby transforming the course slurry into a finer slurry.

22. The shaker screen method of claim 1, further comprising damaging the chosen ID marker after removing the chosen screen from the main container.

23. The shaker screen method of claim 21, wherein the data includes a screen manufacturer identifier pertaining to at least one screen of the plurality of screens.

24. The shaker screen method of claim 21, wherein the data includes a screen size pertaining to at least one screen of the plurality of screens.

25. The shaker screen method of claim 21, wherein the data includes a time-of-day stamp.

26. The shaker screen method of claim 21, wherein the data includes a date stamp.

27. The shaker screen method of claim 21, wherein the data includes a GPS coordinate value.

28. The shaker screen method of claim 21, further comprising at least one of the local computer system and the distant computer system providing an excess usage notification if the plurality of screens are removed from the main container at a removal rate that exceeds a predetermined limit.

29. The shaker screen method of claim 21, further comprising the local computer system providing a drill depth prompt in response to the local computer system determining that the chosen screen has been removed from the main container.

30. The shaker screen method of claim 21, further comprising the second ID reader detecting the chosen ID marker at the screen shaker.

31. The shaker screen method of claim 21, wherein the data indicates whether the chosen screen was installed in the screen shaker.

32. The shaker screen method of claim 21, wherein the data indicates whether the chosen screen was removed from the screen shaker.

33. The shaker screen method of claim 21, further comprising a person unlocking a door on the main container, wherein the data includes information that identifies the person.

34. The shaker screen method of claim 21, further comprising the local computer system sending an outgoing text message to a portable digital device of an advisor, wherein the outgoing text message pertains to at least one of the chosen screen, the data, a screen size of the chosen screen, and a current drill depth associated with the oilfield.

35. The shaker screen method of claim 34, further comprising the portable digital device sending a response message to at least one of the local computer system and the distant computer system, wherein the response message indicates at least one of an acknowledgement, an approval, and a disapproval pertaining to the outgoing text message.

36. A shaker screen method that involves the use of a slurry with a plurality of particles, the shaker screen method comprising:
sheltering an ID marker and a screen within a subcontainer;
sheltering the subcontainer within a main container while the ID marker and the screen are sheltered within the subcontainer;
removing the subcontainer, the screen and the ID marker from within the main container;
removing the screen and the ID marker from within the subcontainer such that the ID marker is more exposed and vulnerable to damage due to discontinued sheltering previously provided by the subcontainer;
directing the slurry across the screen while shaking the screen and the ID marker; and
damaging the screen and the ID marker as a consequence of directing the slurry across the screen while shaking the screen and the ID marker.

37. The shaker screen method of claim 36, further comprising
an ID reader being within communication range of the ID marker when the screen and ID marker is within the main container; and
the ID marker being beyond the communication range of the ID reader when the screen and the ID marker are shaking as the slurry is directed across the screen.

38. The shaker screen method of claim 37, further comprising:
transferring data via a local communication link between the ID reader and the ID marker while the screen and the ID marker are within the main container; and
transferring the data via a long distance communication link between the ID reader and a distant computer system that is at a remote location relative to the ID reader.
